(19) United States
(12) Patent Application Publication
(10) Pub. No.: US 2009/0313803 A1
(43) Pub. Date: Dec. 24, 2009

(54) Method for making a press-in connection between a joining element and a workpiece, press-in connection, and joining element

(75) Inventors: Juliane Niedermuller, Buchenbach (DE); Miriam Tofall, Schwabach (DE); Peter Strempel, Schwabach (DE)

Correspondence Address: LERNER GREENBERG STEMER LLP, P O BOX 2480, HOLLYWOOD, FL, 33022-2480, US

(73) Assignee: RICHARD BERGNER VERBINDUNGSTECHNIK GMBH & CO. KG, Schwabach (DE)

(21) Appl. No.: 12/490,861

(22) Filed: Jun. 24, 2009

(30) Foreign Application Priority Data
Jun. 24, 2008 (DE) 20 2008 008 370.2

(51) Int. Cl. B23P 11/00

(52) U.S. Cl. 29/505; 29/283.5

(57) ABSTRACT

In order to form a reliable, process-safe pressout- and twist-safe press-in connection between a joining element and a workpiece, the joining element is pressed with a shank region into a hole in the workpiece, with shank material of the shank region being pressed into a reception space between the shank region and the hole margin for this purpose, so as to make a frictional connection, without a positive form-lock connection which acts in the axial direction being made. As a result, it becomes possible to have a pressout-safe press-in connection without deformation of the hole, along with a level metal sheet underside, and without the formation of a fastening collar. The press-in connection is suitable particularly in the case of a combination of a low-strength joining element with a higher-strength metal sheet.

The invention relates to a method for making a pressout-safe press-in connection between a joining element and a workpiece, in which the joining element, which has a head region and a shank region adjoining the latter in the axial direction, is pressed into a preformed hole in the workpiece. The invention relates, furthermore, to a press-in connection between a joining element and a workpiece and to a joining element which is designed to be pressed into a preformed hole in a workpiece by means of a method of this type in order to make the press-in connection.

A method of this type and a press-in connection of this type can be gathered from DE 10 2006 019 231 A1. According to this, there is provision whereby the joining element, designed, for example, as a press-in nut or press-in stud, is first inserted, without forming, into a preformed hole in a workpiece. To provide a pressout safeguard in the axial direction, shank material is partially sheared off in a shank region of the joining element with the aid of a suitable press-in tool and is displaced toward the underside of the workpiece, so that the sheared-off material projects at least partially in the radial direction and makes a positive connection acting in the axial direction.

What are understood here to mean joining elements are, in general, functional elements of the type which are designed as connection elements for assembling two workpieces, in particular two metal sheets. In this context, in particular, press-in studs and press-in nuts, as they are known, are considered as joining elements. The joining elements are pressed into the preholed workpiece, and, subsequently, further fastening elements, such as screws or nuts, for fastening further workpieces or other structural elements can be fastened to the joining element.

Metal sheets prepared by means of press-in joining elements of this type are employed in many sectors, in particular also in the motor vehicle sector, mainly in body construction.

With a view to savings in terms of material and weight, high-strength metal sheets are increasingly used particularly in this sector. However, high-strength metal sheets of this type can be formed only with difficulty, and therefore process-safe forming and generation of a high-quality joining connection between the joining element and the high-strength workpiece are possible to only a limited extent.

To provide an axial safeguard, therefore, there is usually provision whereby, when the joining element is being pressed in, material of the joining element is formed and, for example, constitutes a peripheral securing collar for the purpose of making an axial positive connection. Furthermore, the embodiment according to DE 10 2006 019 231 A1 is based on the special set problem of using high-grade steel joining elements which can again themselves be formed only with difficulty. Instead of the forming of the shank region, therefore, a partial shearing off of shank material is provided, which shank material is scraped toward the underside of the workpiece at discrete circumferential points only, so that individual securing noses are formed.

However, the securing noses or securing collar occurring for the purpose of making the axial positive connection are often undesirable for subsequent machining steps, for example when further components are attached. Instead, the aim is to have as planar and level an underside of the workpiece as possible even in the region of the joining element and even in the case of high-strength metal sheets.

In addition to pullout safety, as a rule, a twist-safe arrangement of the joining elements in the workpiece is additionally required. This is usually achieved by means of a positive connection, active in the circumferential direction, between the joining element and a hole margin of the hole in the workpiece. For example, knurled nuts, as they are referred to, are known, which engage with their knurling into the hole margin. In DE 10 2006 019 231 A1, a twist safeguard is achieved in that the individual securing noses are formed into the workpiece underside.

Proceeding from this, the object on which the invention is based is to make it possible to have, process-safe, a press-in connection with the desired pressout and preferably also twist safety, even when high-strength steels are used.

The object is achieved, according to the invention, by means of a method as claimed in claim 1 and by means of a press-in connection as claimed in claim 11. Accordingly, to make a pressout-safe press-in connection, there is provision whereby shank material is pressed into a reception space between a hole margin of the hole in the workpiece and the shank region of the joining element, without a positive connection which acts in the axial direction projecting beyond an underside of the workpiece being made.

The geometries of the shank region of the joining element and those of the hole are first coordinated with one another in such a way that an intermediate space or free space is formed in the radial direction in the non-pressed initial state. The radial extent of the shank region is therefore markedly smaller than that of the hole. The difference in radial extent is in this case greater by a multiple than a conventional “introduction play” which is provided for the easy introduction of the joining element in the case of conventional joining element/workpiece pairings. This requirement that the radial extent of the joining element is markedly smaller than that of the hole is preferably fulfilled over the entire circumference, but at least in the circumferential regions in which shank material is pressed into the reception space. The reception space is therefore dimensioned, in general, in such a way that the shank material is received completely in the reception space. In particular, the volume of the reception space is in this case larger than the volume of the pressed-in shank material. This is because, by the shank material being pressed in from the underside, the reception space is usually filled completely with the shank material in the lower axial region only, as seen in cross section, whereas a free space remains in the upper axial region toward the head region of the joining element. This allows a process-safe complete pressing of the shank material into the reception space.

It is especially important that the shank material does not make a positive connection acting in the axial direction with the hole margin, that is to say the shank material does not project beyond the hole margin in the radial direction and forms no peripheral securing collar which projects beyond the workpiece underside. This ensures that the underside is level in the region of the pressed-in material. The pressed-in material is in this case preferably planar-flush with the underside. The hole margin on the underside in this case remains non-deformed. The underside and the top side of the workpiece normally run parallel to one another in the region of the hole margin, as in the initial state. Moreover, in particular, the underside of the workpiece has no indentation or gradation. Instead, the hole has an at least essentially cylindrical inner wall over its entire length. The hole is normally produced by means of a stamping operation, in which, as a consequence of production, a slightly conically widening configuration of the hole may take place toward the underside. The inner wall runs at least rectilinearly in the case of both a strictly cylindrical and a slightly conical configuration. The conicity corresponds approximately to what is known as the clearance, that is to say the difference in the radii of a cutting punch and an associated die, by means of which the hole is stamped in. The clearance is usually in the range of 8% to 15% of the thickness of the workpiece.

Pressout safety in the axial direction is preferably ensured solely by means of a frictional/nonpositive connection between the pressed-in shank material and the hole margin. Investigations have shown that, in a press-in connection of this type, which provides a reception space into which shank material is pressed, sufficient pressout or pullout resistance is ensured surprisingly even without an axially acting positive connection. What is understood in this context to mean a positive connection is, in particular, a step-like overlap in the axial direction. This makes it possible, even in the case of high-strength and ultrahigh-strength steel sheets, to have a press-in connection in which no closing bead/securing collar or the like is required on the metal sheet underside, even in the region of the joining element, so that, overall, a level planar metal sheet underside is obtained. A further component to be fastened can therefore readily be laid flat onto the underside of the metal sheet and subsequently be fastened with the aid of the joining element, such as, for example, press-in stud or press-in nut, and by means of a corresponding nut or screw.

The pressing method is in this case comparatively simple and preferably, overall, comprises only two stages. In the first stage, the joining element is inserted with its shank region into the hole, until the head region comes to bear against a top side of the workpiece. In this first stage, preferably, deformation or forming either of the workpiece or of the joining element does not occur. The entire press-in operation is carried out with the aid of a suitable press-in tool which holds the head against the top side of the workpiece. Finally, in the second stage, the shank material is pressed from the underside into the reception space with the aid of a die. This preferably takes place by means of a scraping operation, that is to say one in which shank material is at least partially sheared off and is displaced in the axial direction into the reception space.

According to an expedient design, in addition to the pressout safeguard, a twist safeguard is also ensured solely in the circumferential direction as a result of the frictional connection between the pressed-in shank material and the hole margin. No positive connection between the shank material and hole margin is therefore made even in the circumferential direction.

Insofar as dispensing with a positive connection both in the circumferential direction and in the axial direction is referred to in this context, this is to be understood as meaning a deliberately set macroscopic positive connection in which the overlap between the two parts making the positive connection typically lies in the range of fractions of a millimeter (a few tenths of a millimeter) to a few millimeters.

Preferably, shank material is pressed into the reception space at discrete circumferential points only. Frictional connection points are therefore formed, distributed over the circumference, at individual, preferably few, for example four to eight points. The formation of discrete frictional connection points arranged, distributed over the circumference, can be implemented, process-safe, in the method, since any excess shank material can also be deflected in the circumferential direction. Moreover, this has proved to be especially efficient with regard to a reliable twist safeguard.

Particularly in terms of a simple process-safe formation of the discrete frictional connection points, the shank region preferably has a polygonal cross-sectional contour, and the shank material in the corner regions formed by the polygonal outer contour is pressed into the reception space. The shank region has, for example, a hexagonal cross-sectional geometry. The corner regions, that is to say the axially running edges of the polygonal structure of the shank region, can be pressed into the reception space in a simple way by means of an annular die.

According to a preferred development, there is provision, in general, for the hole margin to remain non-deformed during the pressing-in operation. The original cross-sectional geometry, in particular circular geometry, of the hole is therefore preserved both in the axial direction and in the circumferential direction. At most insignificant deformations in the micro-scale range (up to a maximum of about 20 μm) may occur.

The shank region is expediently partially sheared off over a predetermined shearing length, the shearing length preferably lying approximately in the range of 0.25 to 4 times the thickness of the metal sheet. The shearing length is a parameter, via which the volume of the sheared-off and pressed-in material is determined. The selection of the shearing length in this case also depends particularly on the selection of the respective thickness. What applies in general is that, in the case of thin metal sheets with a thickness in the range of about 0.5-1 mm, the shearing length lies in the upper range, and in the case of thick metal sheets with a thickness in the range of, for example, 5-10 mm, the shearing length lies to a greater extent in the lower range.

In order to achieve sufficient pressout and twist safety, the radial extent of the shank region preferably lies approximately in the range of between 0.7 to 0.9 times the radial extent of the hole. The radial extent of the shank region is understood in this case to mean the distance between two opposite portions of the shank region. The radial extent is therefore understood to mean the diameter in the case of a round geometry and, in particular, what is known as the width across flats in the case of a polygonal geometry. The width across flats is understood, in general, to mean the distance between two parallel faces of the polygonal geometry and is a standardized dimension for wrenches.

A further parameter, via which the quantity of the pressed-in material is determined, is the diameter of the die which is used in the pressing-in operation. The individual parameters are coordinated with one another in such a way that a material quantity sufficient for pressout safety is pressed into the reception space and, at the same time, it is ensured that the pressed-in material is at least planar-flush with the metal sheet underside and does not project in the axial direction. The entire sheared-off material is pressed completely into the reception space.

The method is suitable particularly for the introduction of joining elements which have a lower strength than the workpiece. In particular, the method is suitable for the introduction of joining elements into high-strength and ultrahigh-strength metal sheets. The strength (mean tensile strength Rₘ determined by the tension test according to DIN EN 10002-1) of high-strength and ultrahigh-strength metal sheets of this type lies, for example, in the range of higher than 1200 N/mm². Joining elements suitable for this purpose preferably have a strength in the range of 800 N/mm² to 1200 N/mm².

A particular advantage of the method described here is to be seen in that this method and the joining elements used can be employed for a multiplicity of different applications and also for a multiplicity of different material pairings in terms of the strength values. The joining elements can equally also be inserted into workpieces of equal or even lower strength. In this case, the same pressing-in tool can be employed. If the workpiece has a lower strength than the joining element, the latter can be pressed in even as a result of deformation of the hole region. In this case, the shank region would then have a greater radial extent than the hole. Also, in the case of suitable strength ratios, material on the underside of the hole margin can be displaced and shank material pressed in, so that, in this case, an axial positive connection is made.

The use of a polygonal outer contour of the shank region, for example a hexagonal outer contour, in combination with a circular cross-sectional contour of the hole, has proved to be particularly expedient, at the same time the radial extent of the shank region lying in the range of 0.7 to 0.9 times and, in particular, in the range of 0.75 to 0.85 times the diameter of the hole. Furthermore, the shank material in the corner regions is sheared off and is pressed into the reception space at the discrete circumferential positions defined by the corner regions.

An exemplary embodiment of the invention is explained in more detail below by means of the figures. In each case in diagrammatic simplified illustrations:

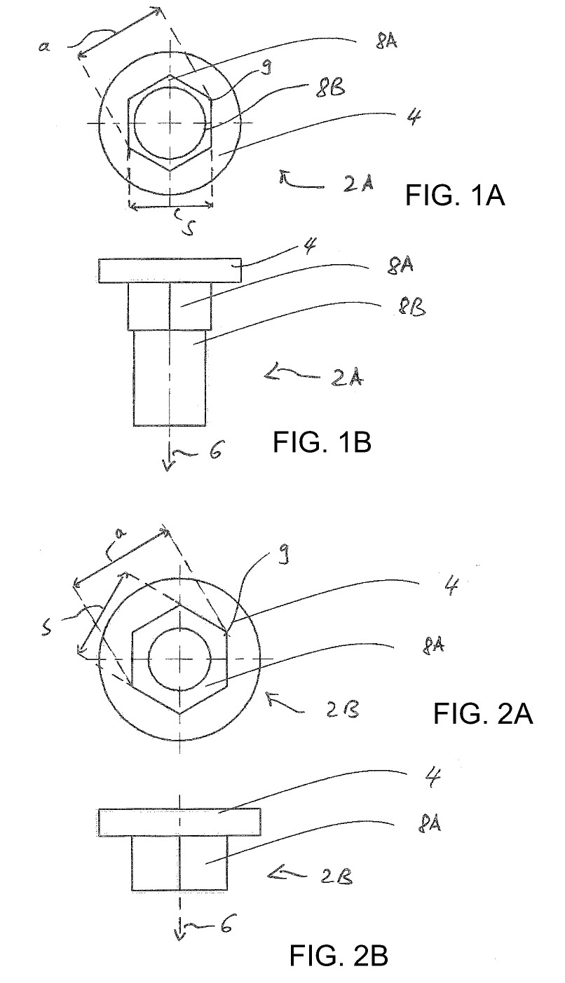

FIG. 1A shows a plan view from below of a joining element designed as a press-in stud,

FIG. 1B shows a side view of the press-in stud according to FIG. 1A,

FIG. 2A shows a plan view from below of a joining element designed as a press-in nut,

FIG. 2B shows a side view of the press-in nut according to FIG. 2A,

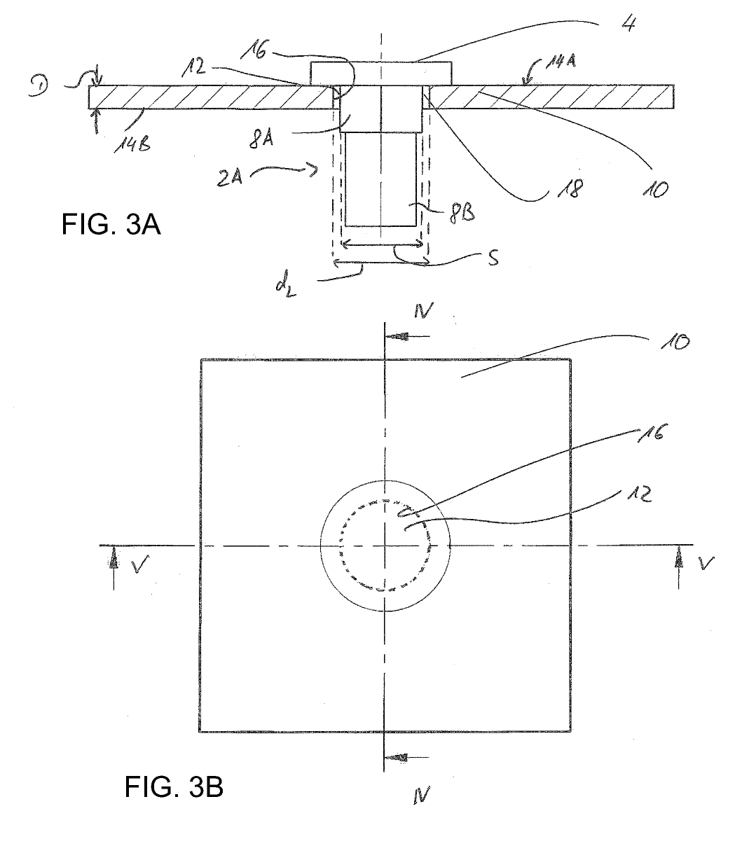

FIG. 3A shows a partially sectional side illustration of a press-in stud seated loosely, in a side view, in a hole of a workpiece formed as a metal sheet,

FIG. 3B shows a plan view from above of the metal sheet with the press-in stud,

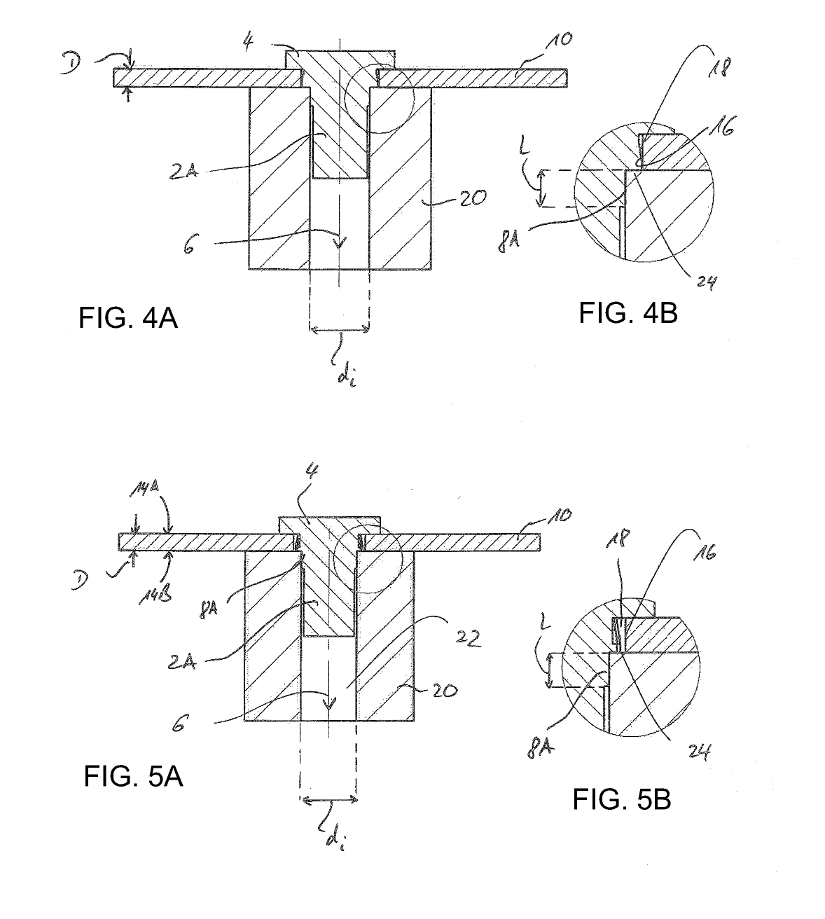

FIG. 4A shows a press-in connection, together with a press-in die, in a sectional illustration along the sectional line IV-IV in FIG. 3B,

FIG. 4B shows an enlarged illustration of the region identified by a circle in FIG. 4A,

FIG. 5A shows a sectional view, similar to FIG. 4A, along the sectional line V-V in FIG. 3B, and

FIG. 5B shows an enlarged illustration, in the form of a detail, of the region marked by a circle in FIG. 5A.

Identically acting parts are illustrated by the same reference symbols in the figures.

FIGS. 1 and 2 illustrate respectively in a side illustration and in a view from below a press-in stud 2A and a press-in nut 2B as press-in or joining elements. The joining elements 2A, 2B have in each case a head region 4 which, in the exemplary embodiment, is designed in the manner of a circular disk. The underside of the head region 4 has adjoining it in the axial direction 6 a shank region with a smaller radial extent, as compared with the head region 4. The shank region comprises a near-head upper shank region 8A which, in the exemplary embodiment, has a polygonal, in particular hexagonal, cross-sectional contour. In the case of the press-in stud 2A, the upper shank region 8A also has adjoining it a lower shank region 8B. The latter has a circular cross section and is usually provided with a thread, so that a screw can be screwed onto the press-in stud 2A. In the case of the press-in nut 2B, the shank region is formed solely by the upper shank region 8A which in this case is usually designed as a hollow shank with an internal thread.

On account of the polygonal configuration, the upper shank region 8A has corner regions 9. The corner regions 9 are spaced apart from one another at a distance a, as seen in cross section. The distance between two side faces oriented parallel to one another defines the width across flats s as the radial extent of the upper shank region 8A.

The method for making a press-in connection between the joining elements 2A, 2B and a workpiece formed in the exemplary embodiment as a metal sheet 10 and having a thickness D is explained in more detail below with reference to FIGS. 3 to 5.

In a first step illustrated in FIGS. 3A, B, the joining element, in the exemplary embodiment of the press-in stud 2A, is inserted into a preformed hole 12 in the metal sheet 10, so that the press-in stud 2A bears with its head region 4 on the top side 14A of the metal sheet. In the exemplary embodiment, the hole 12 has a circular cross section and is delimited by a hole margin 16. The hole 12 has a hole diameter d_{L}. In FIG. 3A, in the selected side view, the press-in stud 2A is positioned in such a way that the lateral boundary lines of the upper shank region 8A are formed by two opposite parallel faces of the hexagonal shank region 8A. The hexagonal shank region 8A has as its radial extent a width across flats s. The width across flats s amounts, for example, to 0.7 to 0.9 times the hole diameter d_{L}. Since the radial extent of the upper shank region 8A is markedly smaller than that of the hole 12, the press-in stud 2A is seated virtually loosely in the hole 12. A reception region 18 is formed between the upper shank region 8A and the hole margin 16.

Proceeding from FIG. 3, the actual pressing in of the joining element 2A takes place in a second method step. For this purpose, as may be gathered from FIGS. 4, 5, a die 20 of a press-in tool, not illustrated in any more detail here, is moved from below, opposite to the axial direction 6, against the metal sheet 10, in the exemplary embodiment until it comes to bear on the underside 14B of the latter. At the same time, the head region 4 is pressed against the top side 14A in the opposite direction by means of a punch or holding-down device, not illustrated in any more detail here. The die 20, which is illustrated in only greatly simplified form, has a central inner cavity 22. On the top side oriented toward the metal sheet 10, the inner cavity 22 is delimited by a peripheral edge which is designed as a scraping or shearing edge 24.

As illustrated in the exemplary embodiment, the shearing edge 24 is preferably of circular design with an inside diameter dᵢ. The inside diameter dᵢ is generally smaller than the maximum radial extent of the upper shank region 8A, that is to say, in the exemplary embodiment, at least smaller than the distance a between corner regions 9 lying diagonally opposite one another. The inside diameter dᵢ is also preferably, in addition, at least slightly smaller than the width across flats s. By virtue of this measure, in the pressing-in operation, shank material of the upper shank region 8A is sheared off opposite to the axial direction 6 by the shearing edge 24 and is pressed upward into the reception space 18. On account of the selected size of the inside diameter dᵢ, the upper shank region 8A is scraped off annularly. Owing to the polygonal cross-sectional contour, markedly more material is scraped off in the corner regions 9 and introduced into the reception space 18. In this case, during shearing off, material is sheared off only over a shearing length 1. In the exemplary embodiment, the shearing length 1 is determined from the difference between the axial overall length of the upper shank region 8A and the thickness D of the metal sheet 10.

On account of the polygonal outer contour of the upper shank region 8A, a plurality of in each case nonpositive or frictional connections between the sheared-off shank material and the hole margin 16 are formed only in the region of the corner regions 9, as can be seen from FIGS. 4A, 4B. In these regions, therefore, the sheared-off shank material is pressed into the reception space 18 so as to make the frictional/nonpositive connection. In the remaining circumferential regions, the shank material does not make frictional connection with the hole margin 16, as can be gathered from FIG. 5B.

The quantity of the shank material introduced into the reception space 18 is determined, on the one hand, by the selected geometries of the shearing edge 24 and of the upper shank region 8A and also by the selected shearing length 1. These geometry relations are selected in such a way that frictional connections are formed only at discrete points in the corner regions 9. Alternatively, in principle, there is the possibility of dimensioning the volume of the shank material sheared off over the entire circumference in such a way that a frictional connection is made over the entire circumference. In this case, use may be made of the fact that the shank material pressed into the reception space 18 tapers conically toward the top side 14A, as seen in the axial direction 6, so that, even in the case of a peripheral annular frictional connection, a residual free volume remains in the upper region of the reception space 18. This residual reception volume ensures process-safe pressing in, for example even in the case of tolerance inaccuracies.

FIGS. 4 and 5 show the situation immediately after the termination of the pressing-in operation, that is to say when the press-in connection is completed. The die 20 is simply moved back again. As can be seen, in spite of the press-in connection, the joining element 2A is flush, completely planar and level, with the underside 14B, without a bead or collar being formed with the sheet underside 14B, and without the metal sheet 20 being deformed in the region of the hole margin 16. In particular, the underside 14B is in alignment with the material pressed into the reception space 18. Alternatively, by virtue of a corresponding design of the die, this material is also set back somewhat from the underside 14B toward the head region 4. As a result of the individual discrete frictional connections according to FIG. 4 which are distributed around the circumference, both sufficient pullout safety in the axial direction 6 and sufficient twist safety in the circumferential direction are afforded.

The method described here is suitable particularly for the combination of joining elements 2A, 2B of lower strength with higher-strength workpieces 10. Furthermore, a particular advantage is to be seen in that other press-in connections, such as, for example, those described in DE 10 2006 019 231 A1, could also be made by means of the same press-in tool. If metal sheets 10 having a lower strength than the joining element 2A, 2B are used, the shank region 8A may also have a greater radial extent, so that the metal sheet is formed even during the insertion of the joining element 2A.

Alternatively to the variant described here, there is also the possibility of selecting the twist safeguard by means of a positive connection due to a suitable cross-sectional shape of the hole and/or of the upper shank region.

### LIST OF REFERENCE SYMBOLS

2A Press-in stud
2B Press-in nut
4 Head region
6 Axial direction
8 Shank region
8A Upper shank region
8B Lower shank region
9 Corner region
10 Metal sheet
12 Hole
14A Top side
14B Underside
16 Hole margin
18 Reception space
20 Die
22 Inner cavity
24 Shearing edge
a Distance
D Thickness
dᵢ Inside diameter
d_{L} Hole diameter
l Shearing length
s Width across flats

1-17. (canceled)

18: A method of forming a pressout-safe press-in connection between a joining element and a workpiece, the method which comprises:
providing a joining element with a head region and a shank region adjoining the head region in an axial direction, and a workpiece with a preformed hole having a hole margin;
pressing the joining element into the preformed hole in the workpiece, wherein in a non-pressed initial state, a reception space for shank material of the shank region is formed between the shank region and the hole margin of the hole; and
forming a pressout safeguard by pressing shank material into the reception space, substantially without forming a positive connection acting in an axial direction and projecting beyond an underside of the workpiece.

19: The method according to claim 18, which comprises forming a twist safeguard in a circumferential direction solely as a result of a frictional connection between the pressed-in shank material and the hole margin.

20: The method according to claim 18, which comprises pressing the shank material into the reception space at discrete circumferential points only.

21: The method according to claim 18, wherein the shank region has a polygonal cross-sectional contour with corner regions, and the forming step comprises pressing shank material from the corner regions formed by the polygonal outer contour into the reception space.

22: The method according to claim 18, wherein the hole margin remains non-deformed during and after the forming step.

23: The method according to claim 18, which comprises partially shearing off shank material in the shank region over a predetermined shearing length (l) and pressing the sheared-off shank material into the reception space.

24: The method according to claim 23, wherein the component has a given thickness and the shearing length lies in a range of 0.25 to 4 times the thickness of the component.

25: The method according to claim 18, wherein the shank region has a radial extent corresponding approximately to 0.7 to 0.9 times a radial extent of the hole.

26: The method according to claim 18, wherein the material of the workpiece has a higher strength than a strength of the joining element.

27: The method according to claim 18, wherein the shank region has a polygonal outer contour and the hole is a bore with a circular cross-sectional contour having a bore diameter, wherein a radial extent of the shank region lies in a range of 0.7 to 0.9 times the bore diameter, and which comprises partially shearing off corner regions formed by the polygonal outer contour and pressing sheared-off shank material completely into the reception space.

28: A press-in connection between a joining element and a workpiece, comprising:
a joining element formed with a head region and a shank region adjoining said head region;
the workpiece having a hole with a hole margin formed therein and said shank region of said joining element being pressed into said hole;
said shank region and said hole margin of said hole defining a reception space therebetween; and
wherein said reception space has shank material pressed therein so as to form a pressout safeguard, and substantially no positive connection that acts in an axial direction and projects beyond an underside of the workpiece formed between said shank material and the workpiece.

29: The press-in connection according to claim 28, wherein a twist safeguard is formed in a circumferential direction between said joining element and the workpiece solely as a result of a frictional connection between the pressed-in said shank material and said hole margin.

30: The press-in connection according to claim 28, wherein said shank material is pressed into said reception space at discrete circumferential points only.

31: The press-in connection according to claim 28, wherein said hole margin is non-deformed.

32: The press-in connection according to claim 28, wherein said shank region has a polygonal outer contour and said hole is a bore with a circular cross-sectional contour, and wherein a radial extent of said shank region lies in a range of 0.7 to 0.9 times a diameter of said bore in a non-deformed initial state, and wherein corner regions formed by the polygonal outer contour are partially sheared off, and the sheared-off said shank material is pressed into the reception space.

33: A joining element for use in the method according to claim 18 and configured to be pressed into a preformed hole in a workpiece, the joining element comprising:
a head and a shank adjoining said head and extending in an axial direction;
said shank having a predefined geometry configured such that, when said shank is pressed into the hole in the workpiece with a predetermined hole geometry, a press-in connection is formed wherein:
the shank and a margin of the hole define a reception space therebetween; and
the reception space has shank material pressed therein so as to form a pressout safeguard, and substantially no positive connection that acts in an axial direction and projects beyond an underside of the workpiece formed between said shank and the workpiece.

34: The joining element according to claim 33, configured for insertion into a hole having a predetermined radial extent, and wherein a radial extent of said shank lies in a range of 0.7 to 0.9 times a radial extent of the hole.

35: A joining element for forming a press-in connection according to claim 28 and configured to be pressed into a preformed hole in a workpiece, the joining element comprising:
a head and a shank adjoining said head and extending in an axial direction;
said shank having a predefined geometry and being configured for a process which comprises:
inserting said joining element with said shank into the preformed hole in the workpiece, wherein in a non-pressed initial state, a reception space for shank material of said shank is formed between said shank and a hole margin of the hole; and
forming a pressout safeguard by pressing shank material into the reception space, substantially without forming a positive connection acting in an axial direction and projecting beyond an underside of the workpiece; and
thereby forming a press-in connection according to claim 28.

36: The joining element according to claim 35, configured for insertion into a hole having a predetermined radial extent, and wherein a radial extent of said shank lies in a range of 0.7 to 0.9 times a radial extent of the hole.
